(19) United States
(12) Patent Application Publication
(10) Pub. No.: US 2013/0099455 A1
(43) Pub. Date: Apr. 25, 2013

(54) ROLL STABILIZER FOR INSTALLATION TO A WHEEL SUSPENSION OF A MOTOR VEHICLE

(71) Applicants: Heinrich Beringer, Denkendorf (DE); ANDREAS SCHINDLER, Ingolstadt (DE)

(72) Inventors: Heinrich Beringer, Denkendorf (DE); ANDREAS SCHINDLER, Ingolstadt (DE)

(73) Assignee: AUDI AG, Ingolstadt (DE)

(21) Appl. No.: 13/440,483

(22) Filed: Apr. 5, 2012

(30) Foreign Application Priority Data
Apr. 6, 2011 (DE) 10 2011 016 230.5

(51) Int. Cl. B60G 17/016

(52) U.S. Cl. CPC B60G 17/016
USPC 280/5.508

(57) ABSTRACT

A roll stabilizer for installation to a wheel suspension of a motor vehicle includes a transverse torsion bar rotatably mounted to a body of the motor vehicle and two longitudinal arms which are connected to the torsion bar to thereby establish a substantially U shaped configuration. The longitudinal arms are articulated directly or indirectly to wheel control elements of the wheel suspension. A servomotor is arranged at one end of the torsion bar between one of the longitudinal arms and the torsion bar for adjusting the longitudinal arms in relation to one another to thereby stabilize a rolling motion.

### CROSS-REFERENCES TO RELATED APPLICATIONS

This application claims the priority of German Patent Application, Serial No. 10 2011 016 230.5, filed Apr. 6, 2011, pursuant to 35 U.S.C. 119(a)-(d), the content of which is incorporated herein by reference in its entirety as if fully set forth herein.

### BACKGROUND OF THE INVENTION

The present invention relates to a roll stabilizer for installation to a wheel suspension of a motor vehicle.

The following discussion of related art is provided to assist the reader in understanding the advantages of the invention, and is not to be construed as an admission that this related art is prior art to this invention.

U-shaped roll stabilizers for installation on wheel suspensions of motor vehicles are generally known in the art in order to prevent the body to excessively tilt to the side when negotiating a curve. Stabilizers of this type include a torsion bar having two longitudinal arms attached to the torsion bar.

It would be desirable and advantageous to provide an improved roll stabilizer which obviates prior art shortcomings and is simple in structure while yet reliable in operation and which is easy to suit to installation conditions at hand.

### SUMMARY OF THE INVENTION

According to one aspect of the present invention, a roll stabilizer for installation to a wheel suspension of a motor vehicle includes a transverse torsion bar rotatably mounted to a body of the motor vehicle, two longitudinal arms connected to the torsion bar to thereby establish a substantially U shaped configuration, the longitudinal arms being articulated directly or indirectly to wheel control elements of the wheel suspension, and a servomotor arranged at one end of the torsion bar between one of the longitudinal arms and the torsion bar for adjusting the longitudinal arms in relation to one another to thereby stabilize a rolling motion.

As the central torsion bar is connected to the body of the motor vehicle by two axial longitudinal arms, and the servomotor is arranged at one end of the torsion bar in the force flux between the one longitudinal arm and the torsion bar, relative small structural modifications are involved to stabilize rolling motion when compared with a stabilizer arrangement without servomotor. The lateral disposition of the servomotor simplifies hereby the installation in the motor vehicle. The roll stabilizer with servomotor can thus be pre-assembled as a unitary structure and mounted in the motor vehicle via existing mounting points in a simple manner.

According to another advantageous feature of the present invention, the servomotor can be positioned laterally outside of the one longitudinal arm. Advantageously, the torsion bar can be passed through the one longitudinal arm and connected in driving relation with the servomotor. As a result, the servomotor is situated at a well-accessible region of the body of the motor vehicle approximately in proximity of one wheel of the wheel suspension.

According to another advantageous feature of the present invention, the servomotor has a housing which can be attached to the one longitudinal arm. Advantageously, the servomotor has an output element in driving relation with the torsion bar. This results in a simple and effective construction and unites the servomotor with the one longitudinal arm in the absence of any further fasteners. The servomotor and its housing operate directly as reaction member to adjust the longitudinal arms of the stabilizer in opposite directions.

According to another advantageous feature of the present invention, the other one of the longitudinal arms in opposition to the servomotor can be formed directly onto the central torsion bar. As a result, torsion bar and longitudinal arm form an assembly that is functionally robust, simple in construction, and easy to install.

According to another advantageous feature of the present invention, the servomotor can be operated hydraulically or electrically. Advantageously, the servomotor may include an electric motor and an output transmission, with the electric motor having a rotor configured for operating the transmission. The transmission may be configured as a planetary gear mechanism, cycloidal gear mechanism, or harmonic drive, with the transmission having an output element connected in driving relation with a free end of the torsion bar. The transmission allows great ratios of multiplication so as to enable the use of relatively small electric motors while ensuring high output torques.

According to another advantageous feature of the present invention, the torsion bar and the servomotor can be positioned anteriorly of the wheel suspension, when the wheel suspension involves a front wheel suspension, or behind the wheel suspension, when the wheel suspension involves a rear wheel suspension. As a consequence of the spatial remoteness from the passenger cell of the motor vehicle, the freedom of design for installing the stabilizer is increased while requiring merely modest measures to insulate noise. The location of a roll stabilizer according to the present invention can be best suited to the situation at hand anteriorly or behind the front or rear wheel suspension.

According to another aspect of the present invention, a method for installing a roll stabilizer to a wheel suspension of a motor vehicle includes rotatably mounting a torsion bar of the roll stabilizer to a body of a motor vehicle, articulating two longitudinal arms of the torsion bar directly or indirectly to wheel control elements of a wheel suspension, and arranging a servomotor at one end of the torsion bar between one of the longitudinal arms and the torsion bar for adjusting the longitudinal arms in relation to one another to thereby stabilize a rolling motion.

### BRIEF DESCRIPTION OF THE DRAWING

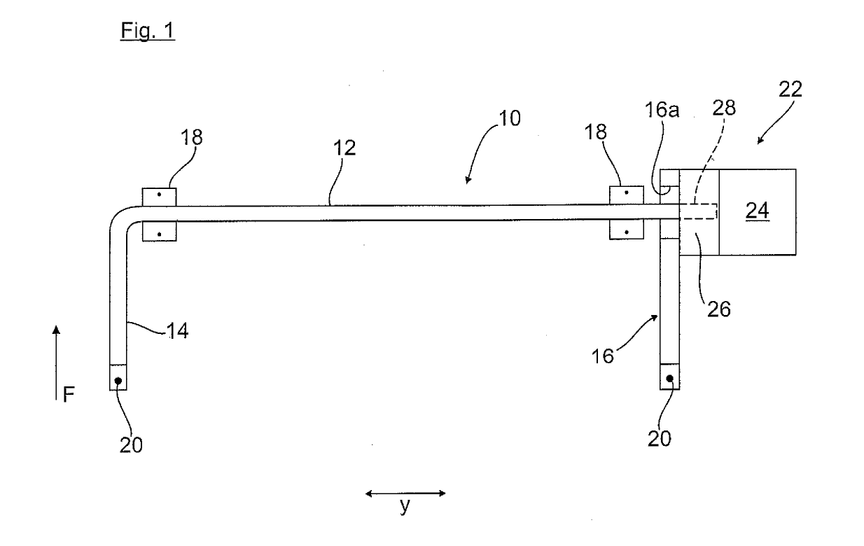

Other features and advantages of the present invention will be more readily apparent upon reading the following description of currently preferred exemplified embodiments of the invention with reference to the accompanying drawing, in which the sole FIG. 1 shows a schematic illustration of a roll stabilizer according to the present invention for a wheel suspension of a motor vehicle in top view.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiment may be illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a schematic illustration of a roll stabilizer according to the present invention, generally designated by reference numeral 10 for installation to a not shown structure of the body of a motor vehicle. The stabilizer 10 includes a central transverse torsion bar 12 and two lateral longitudinally arms 14, 16.

In the exemplified embodiment of FIG. 1, the roll stabilizer 10 can be arranged anteriorly of a front wheel suspension (not shown) of the motor vehicle. The torsion bar 12 is rotatably supported by two lateral and axially spaced mounting points 18 to the body. The mounting points 18 can be of any suitable and known construction and therefore are not described in detail for the sake of simplicity.

The longitudinal arms 14, 16 positioned in travel direction F anteriorly of the wheel suspension are pivotally connected in a manner not shown in detail at attachment points 20 directly or indirectly via vertical struts for example, to wheel control elements, such as e.g. wheel carrier, control arm, etc. of the wheel suspension. The longitudinal arm 14 of the roll stabilizer 10 on the left-hand side of the drawing is formed directly onto the torsion bar 12 and may be made for example of round spring steel with flattened end at attachment point 20. The longitudinal arm 16 of the roll stabilizer 10 on the right-hand side of the drawing is a separate component which is made of steel or lightweight metal and may have, for example, a rectangular cross section which tapers towards the attachment point 20. The longitudinal arm 16 has an opening 16a to allow passage of the right-hand end of the torsion bar 12.

A servomotor, generally designated by reference numeral 22 and shown only schematically, is mounted to the outside of the longitudinal arm 16 by suitable fasteners (not shown). The servomotor 22 includes an electric motor 24 and a transmission 26. The electric motor 24 has a housing in which a rotor (not shown) of the electric motor 24 is supported for operating the transmission 26. Examples of transmissions 26 include a cycloid gear mechanism, a respectively geared-down planetary gear train, or a harmonic drive. Currently preferred is a configuration of the transmission 26 as a cycloid gear mechanism of conventional type. The transmission 26 has an output element which is in driving relation with the end of the torsion bar 12 via a formfitting plug connection 28 (shown in dashed line) in circumferential direction. As a result, a drive connection is established in the force flux between the torsion bar 12 and the right-hand longitudinal arm 16 of the roll stabilizer 10 to swing the longitudinal arm 16, supported via the housing of the servomotor 22, in relation to the torsion bar 12 and thus in relation to the longitudinal arm 14. The drive connection is configured in such a way as to ensure at the same time a stable support and mount of the servomotor 22 secured in a “cantilever” manner to the torsion bar 12 and longitudinal arm 16.

By controlling the electric motor 24 to operate in one or the other rotation direction via an electronic control device, e.g. of an electronic driving stability program, in response to driving dynamic parameters such as vehicle speed, steering angle of the steered wheels, transverse acceleration, etc., the longitudinal arm 16 can be adjusted in relation to the torsion bar 12 and the longitudinal arm 14 to impress on the left and right wheel suspension a spring torque which superimposes the vehicle suspension and thereby counteracts a respective side tilt of the vehicle body.

The roll stabilizer 10 can be combined with the servomotor 22 to establish a pre-assembly unit, as indicated in FIG. 1. This pre-assembly unit can be installed into the motor vehicle with little effort.

While the invention has been illustrated and described in connection with currently preferred embodiments shown and described in detail, it is not intended to be limited to the details shown since various modifications and structural changes may be made without departing in any way from the spirit and scope of the present invention. For example, the roll stabilizer 10 may be positioned on a rear wheel suspension of the motor vehicle, with the longitudinal arms 14, 16 oriented forwardly in travel direction F of the motor vehicle so that the torsion bar with the servomotor is further distanced from the passenger cell of the motor vehicle. This arrangement provides greater freedom of design and has acoustic benefits to keep noise, possibly emanating during operation of the servomotor, away from the vehicle interior.

The longitudinal arm 16 and the housing of the servomotor 22 may optionally be made in one piece though casting to thereby form a unitary structure. Optionally, it is also possible to make the longitudinal arm 14 as a separate component for weight reasons and then connect the longitudinal arm 14 with the torsion bar 12 via a plug connection.

It is also possible to provide a third mounting point for the roll stabilizer in an area between the housing of the servomotor 22 and the body of the motor vehicle, e.g. on the free end face of the housing.

The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A roll stabilizer for installation to a wheel suspension of a motor vehicle, comprising:
a transverse torsion bar rotatably mounted to a body of the motor vehicle;
two longitudinal arms connected to the torsion bar to thereby establish a substantially U-shaped configuration, said longitudinal arms being articulated directly or indirectly to wheel control elements of the wheel suspension; and
a servomotor arranged at one end of the torsion bar between one of the longitudinal arms and the torsion bar for adjusting the longitudinal arms in relation to one another to thereby stabilize a rolling motion.

2. The roll stabilizer of claim 1, wherein the servomotor is positioned laterally outside of the one longitudinal arm.

3. The roll stabilizer of claim 1, wherein the torsion bar is passed through the one longitudinal arm and connected in driving relation with the servomotor.

4. The roll stabilizer of claim 1, wherein the servomotor has a housing attached to the one longitudinal arm.

5. The roll stabilizer of claim 1, wherein the servomotor has an output element in driving relation with the torsion bar.

6. The roll stabilizer of claim 1, wherein the servomotor has a transmission, said torsion bar being formfittingly connected by a plug connection to an output element of the transmission in a circumferential direction.

7. The roll stabilizer of claim 1, wherein the other one of the longitudinal arms in opposition to the servomotor is formed onto the torsion bar.

8. The roll stabilizer of claim 1, wherein the servomotor is operated hydraulically or electrically.

9. The roll stabilizer of claim 1, wherein the servomotor includes an electric motor and an output transmission, said electric motor having a rotor configured for operating the transmission, said transmission having an output element connected in driving relation with a free end of the torsion bar.

10. The roll stabilizer of claim 9, wherein the transmission is a gear mechanism selected from the group consisting of planetary gear mechanism, cycloidal gear mechanism, and harmonic drive.

11. The roll stabilizer of claim 9, wherein the electric motor has a housing and a stator received in the housing, said rotor being supported in the housing.

12. The roll stabilizer of claim 1, wherein the torsion bar and the servomotor are positioned anteriorly of the wheel suspension, when the wheel suspension involves a front wheel suspension, or behind the wheel suspension, when the wheel suspension involves a rear wheel suspension.

13. The roll stabilizer of claim 1, wherein the torsion bar is supported directly on the body of the motor vehicle by at least two mounting points in axially spaced-apart relationship.

14. The roll stabilizer of claim 1, wherein the servomotor is secured in a cantilever manner to the torsion bar and the one longitudinal arm.

15. A method for installing a roll stabilizer to a wheel suspension of a motor vehicle, said method comprising:
rotatably mounting a torsion bar of the roll stabilizer to a body of a motor vehicle;
articulating two longitudinal arms of the torsion bar directly or indirectly to wheel control elements of a wheel suspension; and
arranging a servomotor at one end of the torsion bar between one of the longitudinal arms and the torsion bar for adjusting the longitudinal arms in relation to one another to thereby stabilize a rolling motion.

16. The method of claim 15, wherein the servomotor is positioned laterally outside of the one longitudinal arm.

17. The method of claim 15, further comprising passing the torsion bar through the one longitudinal arm and connecting the torsion bar in driving relation with the servomotor.

18. The method of claim 15, further comprising attaching a housing of the servomotor to the one longitudinal arm.

19. The method of claim 15, further comprising connecting an adjustable output element of the servomotor in driving relation with the torsion bar.

20. The method of claim 15, further comprising formfittingly connecting the torsion bar by a plug connection to an output element of a transmission of the servomotor in a circumferential direction.

21. The method of claim 15, further comprising forming the other one of the longitudinal arms onto the torsion bar.

22. The method of claim 15, wherein the servomotor is operated hydraulically or electrically.

23. The method of claim 15, further comprising connecting an output element of a transmission of the servomotor in driving relation with a free end of the torsion bar.

24. The method of claim 15, wherein the torsion bar and the servomotor are positioned anteriorly of the wheel suspension, when the wheel suspension involves a front wheel suspension, or behind the wheel suspension, when the wheel suspension involves a rear wheel suspension.

25. The method of claim 15, wherein the torsion bar is supported directly on the body of the motor vehicle by at least two mounting points in axially spaced-apart relationship.
